(19) United States
(12) Patent Application Publication
(10) Pub. No.: US 2009/0039639 A1
(43) Pub. Date: Feb. 12, 2009

(54) Receiving device for books

(76) Inventors: Justin Hanley, Kelowna (CA); Fred Merz, Kelowna (CA)

Correspondence Address: Beairsto Sabey, 201-401 Glenmore Road, Kelowna, BC, VIV 1Z6, CA

(21) Appl. No.: 12/219,672

(22) Filed: Jul. 25, 2008

Related U.S. Application Data
(60) Provisional application No. 60/935,082, filed on Jul. 25, 2007.

(51) Int. Cl. B42D 17/00; A47B 19/10

(52) U.S. Cl. 281/46; 248/441.1

(57) ABSTRACT

A receiving device to maintain a book in an open position is provided. The receiving device comprises a base and an arm pivotally coupled with the base such that a book may be placed between the base and the arm, said arm retaining the pages on one side of the book in an open position while maintaining the pages on a second side of the book in a relatively flat plane to permit the reader to access the pages on the second side.

### PRIORITY CLAIM

This application claims the benefit to U.S. Provisional Patent Application No. 60/935,082 entitled RECEIVING DEVICE FOR BOOKS filed on 25 Jul., 2007, which is hereby incorporated by reference.

### FIELD OF THE INVENTION

The present invention relates generally to a receiving device for books, and more particularly, it relates to a receiving device which can be used to hold and maintain a book in an opened position.

### BACKGROUND OF THE INVENTION

In many different environments and circumstances such as in the workplace and classroom wherein various types of books are used in conjunction with ongoing work, it is often desirable for such books to be opened, and remain opened in the desired place. For example, in the kitchen of a cooking class, students and instructors may need to refer to recipes and/or instructions during food preparation. Manufacturers may need to flip through a purchase order book to find the order of a particular client to determine how many units of a part has been ordered and what the requested specifications are. Retailers and service providers may need to conveniently find the next blank page in a receipt book to provide customers with a copy of their account. In such examples, it is readily apparent that it is important to have easy and continued access to a particular page of a book by maintaining the book in a desired open position.

Many types of books, including but not limited to soft cover books and especially receipt books, business deposit books, and flip chart pads are difficult to maintain in the desired open position without having to manually hold the book open or use other weighted devices to maintain the book in the desired open position. For example, a business deposit book typically used by any type of business to record finds received through business transactions is usually taken to a financial institution to deposit monies into a business account. Typically, personnel at the financial institution will open the business deposit book to a blank page, bend the binding of the book to encourage the business deposit book to remain in the desired open position, and grab a nearby convenient weighted item such as a stapler or a mug to position precariously over the binding in hopes that the business deposit book will remain open in the desired position long enough to complete the deposit transaction. Because each unused page of the business deposit book comprises duplicate sheets such that a copy of the recorded deposit information may be retained by the financial institution and one copy remains in the business deposit book for the depositor's records, the financial institution personnel must arrange the business deposit book such that records of previous transactions attached to the business deposit book are folded back and away from the next blank page of the business deposit book, along with the front cover of the business deposit book, and secured in such folded back position so as not to interfere with the recording of the next deposit transaction. In addition, a hard surface, typically the back cover of the business deposit book, must be inserted between the blank page being used and the next blank page of the business deposit book so as to prevent information to be recorded in regards to the current deposit transaction from being transferred and copied onto the next blank page. The business deposit book must be maintained in this open position for the duration of the transaction while the financial institution personnel counts the amount of funds being deposited and records such information in the business deposit book. Because the financial institution personnel typically requires use of both hands to perform aspects of the transaction prior to recording information in the business deposit book, a weighted item is usually used to unstably hold the business deposit book in the open position during the transaction process. Very often, the weighted item will roll off or otherwise displace from its position, causing the business deposit book to flip shut or turn to a wrong page. The displacement of the weighted item may occur a plurality of times during a single deposit transaction, creating unwanted and unnecessary frustration and inconvenience for the financial institution personnel who must rearrange the business deposit book each time to the desired open position.

While many different book holding systems and devices are available for maintaining the open position of standard reading books, they are generally unnecessarily complex to construct and use, unwieldy to carry around and set up from one location to another, and not well suited for certain binding styles such as flip chart style books where the spine of the book is along the top edge which is the typical binding style of the above discussed business deposit book.

Devices known for assisting in the holding of a book include U.S. Pat. No. 6,019,339 to Brayford which describes a book holder which permits an open book to be placed between a first and second planar surface so as to keep the pages on each side of the book in a relatively flat plane to permit the reader to read both pages. A book is defined to include, but is not limited to, a hardcover book, a soft cover book, a manual, a pamphlet, a magazine, a phone book, a brochure, a commercial bank deposit book, and a catalogue.

U.S. Pat. No. 4,512,603 to Williams describes a book support system comprised of a housing having a recess formed therein wherein the recess is of predetermined contour and is adapted for insert and receipt of the book. A releasable constrainment mechanism including orthogonally directed first and second resilient members are included to constrain the book within the recess. The releasable constrainment mechanism is secured to the housing and a tab member is provided in a lower section of the housing to allow the user to hold the book support system in one hand while reading.

U.S. Pat. No. 6,672,621 to Moss describes a holding device for a book which includes first and second U-shaped clips wherein each of the U-shaped clips is provided with a strip of flexible material having one end attached to a front leg of the U-shaped clip and an opposed end with an adjustable fastening device thereon, the adjustable fastening devices on the opposed ends being mateable. The front leg of the U-shaped clip may be modified to include an outwardly extending lip with at least one finger thereon to receive a wire or rubber band or the like thereon which is attachable to the top and bottom spine of a binder or folder which allows the receipt of a book, pamphlet, or the like, the book or pamphlet being received between the spine of the binder and the wire, rubber band, or the like.

Certain books, whether they have been used often or not, have bindings which will not consistently allow the book to be opened and remain opened at a desired position. For example, when a business bank deposit books is splayed open such that one side is much thicker than the other side, there is a greater tendency for the business bank deposit book to flip shut. Either the thicker side will uncoil and flip shut or the thinner side will flip up towards the thicker side. Accordingly, there is a need in the art for a device designed to hold a flip chart style book in the open position.

### SUMMARY

It is an object of the invention to provide a portable and compact receiving device for retaining a book of virtually any dimension and thickness in an open position.

It is a further object of the invention to provide a receiving device for retaining a flip chart style book in an open position.

It is a further objection of the invention to provide a stable support for receiving a book of virtually any dimension and thickness.

In accordance with the invention, a receiving device for a book is provided. The receiving device is configured to receive a book so as to maintain such book in a desired open position. A book is defined herein to mean any soft cover book having a spine in which the pages of the book are attached to the spine, including but not limited to a manual, a pamphlet, a magazine, a phone book, a brochure, a commercial business deposit book, a receipt book, and a catalogue.

The receiving device is comprised of a base and an arm pivotally coupled with the base by way of at least one pivot means such that the arm may pivot between a first position and a second position relative to the base. Preferably, the arm is frictionally and pivotally coupled with the base at a first end of the base such that the arm may be maintained in the first or second position unless adjusted otherwise.

When the arm is in the first position, a book may be received on the base for retention of the book in a desired open position. When the book is received on the base in the desired open position, the arm may then be displaced from the first position to the second position such that the arm engages the book so as to retain the book in the desired open position. To release the book from the base, the arm may be displaced from the second position to the first position such that the book may be removed from the base.

In a preferred embodiment of the present invention, the arm is arched and adapted to accommodate the shape and configuration of the pages of the book that are folded over the binding when the book is in the desired open position.

In a further embodiment of the present invention, the receiving device further comprises at least one stabilizing means mounted with a side of the base, the stabilizing means configured to frictionally engage the surface the receiving device rests on such that the receiving device may remain generally stationary on the surface while in use.

### BRIEF DESCRIPTION OF THE DRAWINGS

These and other objects, benefits, or advantages of the invention are described in more detail and will be apparent after reviewing the drawings and description thereof wherein:

FIG. 1 is a side perspective view of a preferred embodiment of the present invention with a book received in the receiving device;

FIG. 2 is a plan perspective view of the device as seen in FIG. 1 in the closed position;

FIG. 3 is a top view of the arm;

FIG. 4 is a front view of the pivot means;

FIG. 5 is a plan perspective view of the invention as seen in FIG. 1 in the open position without the book; and

FIG. 6 is a bottom view of the invention as seen in FIG. 5.

### DETAILED DESCRIPTION OF THE INVENTION

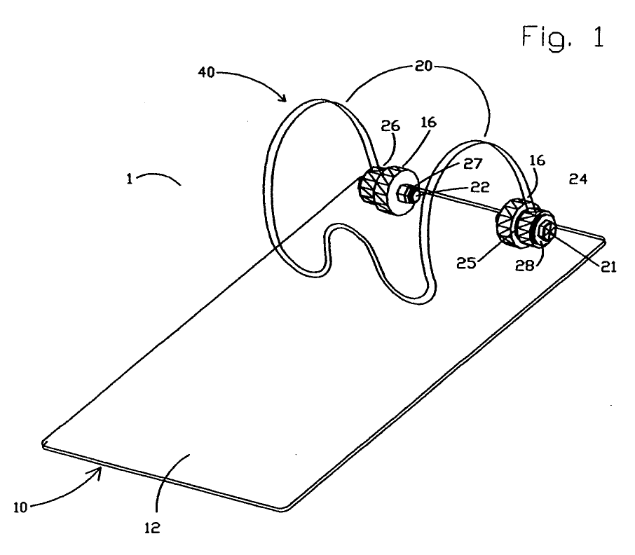

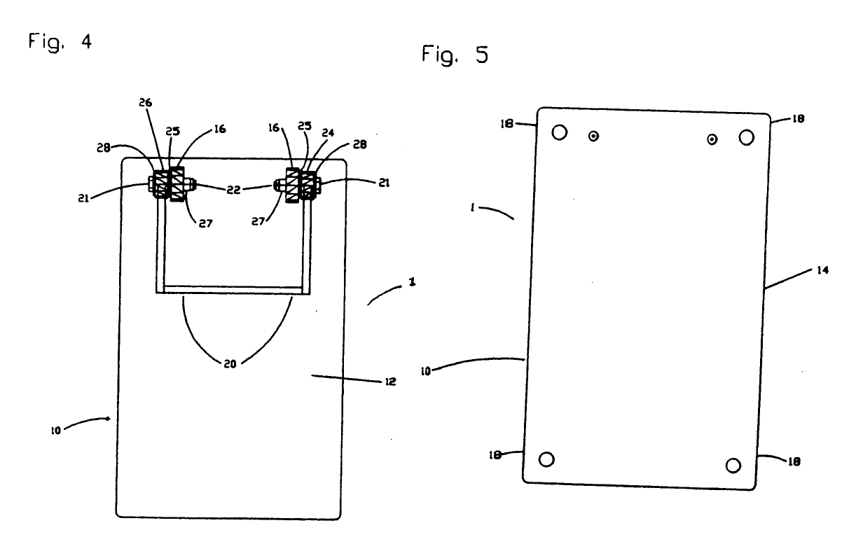

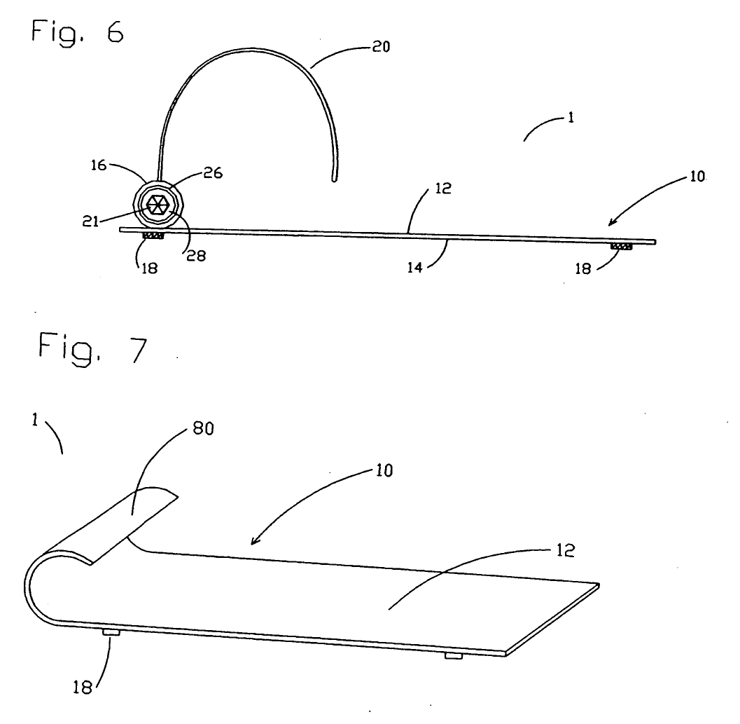

With reference to FIGS. 1 to 6, a receiving device for books 1 comprises a base 10 and an arm 20 pivotably coupled with base 10 such that arm 20 may pivot between a first open position 30 and a second closed position 40 relative to base 10.

Base 10 may be made of any rigid material such as but not limited to metal, wood, fiberglass, plastic, or any other similar resilient material. Preferably, base 10 is made of aluminum and is generally rectangular shaped although base 10 may be of any shape and configuration as long as it may receive and support a book in a substantially flat configuration, as described in greater detail below. The dimensions of base 10 must be larger than the book it is designed to receive. A book is defined herein to mean any soft cover book having a spine in which the pages of the book are attached to the spine, including but not limited to a manual, a pamphlet, a magazine, a phone book, a brochure, a commercial business deposit book, a receipt book, and a catalogue.

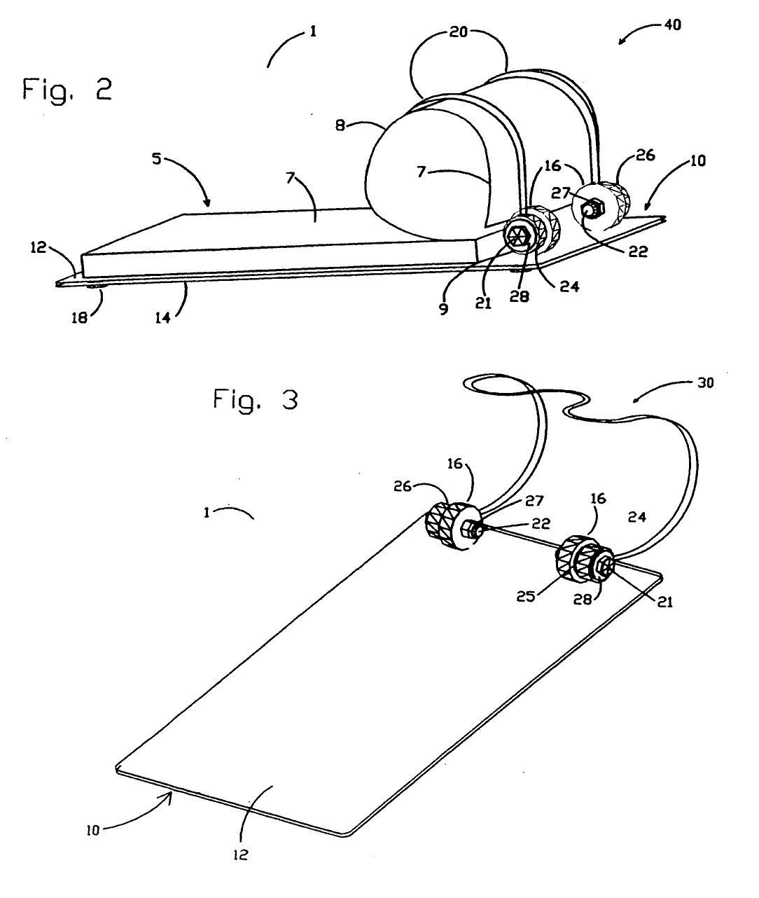

As best seen in FIGS. 1 and 2, in an embodiment of the invention, base 10 may be configured to receive a business deposit book 5. The typical standard dimensions of business deposit book 5 are sixteen centimeters in width by eighteen and a half centimeters in length by one centimeter in depth. In such embodiment wherein receiving device 1 may be used to receive business deposit book 5 having the above set out typical standard dimensions, base 10 may have dimensions of at least sixteen and a half centimeters in width by nineteen centimeters in length so as to define a generally rectangular shape that is slightly larger than the dimensions of business deposit book 5. Alternatively, base 10 may have larger dimensions to accommodate and receive larger books such as a phone book or base 10 may have smaller dimensions to accommodate and receive smaller books such as a receipt book.

In an embodiment of the invention, at a first end of a first side 12 of base 10, at least one support member 16 is provided. Support member 16 may be formed as a part of base 10 or support member 16 may be mounted on base 10. As seen in FIG. 3, in the preferred embodiment, at least two support members 16 are mounted on base 10 at a first end of first side 12 in a spaced apart configuration by way of fastening means including but not limited to screws, bolts, adhesives and welding. Support member 16 may be made of any rigid and durable material such as but not limited to metal, wood, fiberglass, plastic, or any other similar resilient material. Preferably, support member 16 is made from steel and is mounted generally along the edge of the first end of first side 12 of base 10 in a parallel and spaced apart configuration by way of screws. Support member 16 is comprised of an aperture configured to receive a pivot pin such as but not limited to a bolt so as to enable arm 20 to pivot between first position 30 and second position 40 as explained in greater detail below. In the preferred embodiment, the aperture of support member 16 is threaded to receive a bolt 22 to pivotally couple arm 20 to base 10. Alternatively, arm 20 may be pivotably coupled with base 10 by way of any frictional pivot means such as but limited to a ball and socket pivot or detent mechanism that enables arm 20 to be frictionally maintained in first position 30 or second position 40 unless adjusted otherwise.

As seen in FIGS. 2 to 5, in a preferred embodiment of the invention, arm 20 is pivotally coupled with support member 16 on base 10 by way of bolt 22. Arm 20 may be made of any rigid material similar to base 10 such as but not limited to metal, wood, fiberglass, plastic, or any other resilient material. Preferably, arm 20 is made of steel. As seen in FIG. 3, a first end 24 and a second end 26 of arm 20 may each be pivotably coupled with a first and a second support member 16, respectively. Each of first and second end 24, 26 of arm 20 comprise of an aperture generally corresponding to the aperture of support member 16 such that bolt 22 may be inserted through each of the apertures. For greater clarity, a first bolt 22 may be inserted through the apertures of first end 24 and the first support member 16 and a second bolt 22 may be inserted through the aperture of second end 26 and the second support member 16 such that arm 20 may pivot about the first and second bolts 22. Preferably, each of first and second bolts 22 are secured to first and second support members 16 by fastening members such as but not limited to nuts 27. A spring washer 28 may be disposed between the head 21 of the first bolt 22 and the first support member 16. Similarly, spring washer 28 may be disposed between head 21 of the second bolt 22 and the second support member 16. Spring washer 28 provides a compression force to counteract loosening of the connection of the first and second bolts 22 within the apertures of the first and second support members 16 and the first and second ends 24, 26, respectively, so as to maintain the tension that enables the frictional pivot of arm 20. Alternatively, other spring tension means such as but not limited to wave washers may be employed to maintain tension of the first and second bolts 22.

In an embodiment of the invention, a wear pad 25 may be disposed between first end 24 and the first support member 16 and between second end 26 and the second support member 16 to relieve friction between such parts as arm 20 displaces between first position 30 and second position 40. Wear pad 25 may be a washer made of any durable material such as nylon or TEFLON.

In a preferred embodiment of the invention, arm 20 is arched and adapted to accommodate the shape and configuration of pages of a book that are folded over the spine of the book when it is in an open position, as described in greater detail below. As seen in FIGS. 1 and 2, to open business deposit book 5 in the desired position, pages 7 of business deposit book 5 may be folded over the spine 9, the folded over pages 7 thereby forming a curvature 8 on a first side of business deposit book 5 while pages 7 on a second side of business deposit book 5 remain in a relatively flat plane to permit access to such pages 7 on the second side. Without anything constraining folded over pages 7 to maintain business deposit book 5 in the desired open position, the natural tendency of folded over pages 7 is to fold back over spine 9 in the opposite direction towards the second side of business deposit book 5, thereby closing business deposit book 5. When arm 20 is in first position 30, a book such as but not limited to business deposit book 5 opened to a desired position with pages 7 folded over spine 9 thereby creating curvature 8 may be received on base 10. Arm 20 may then be displaced from first position 30 to second position 40 over curvature 8 such that arm 20 engages business deposit book 5. When in second position 40, curvature 8 formed by pages 7 folded over spine 9 may be received in the arch shape of arm 20. Arm 20 may be configured to accommodate the shape and configuration of curvature 8 so as to retain pages 7 in the folded over position when business deposit book 5 is opened to the desired position. When in second position 40, arm 20 engages business deposit book 5 so as to effectively counter the natural tendency of folded over pages 7 from folding back over spine 9 to close business deposit book 5 by maintaining folded over pages 7 within the arch of arm 20. To remove business deposit book 5, arm 20 may be displaced from second position 40 to first position 30 such that arm 20 no longer engages business deposit book 5.

In an alternative embodiment, arm 20 is a flexible curvature on the end of base 10. The flexible curvature may be formed at the end of base 10 or the flexible curvature may be flexibly attached to the end of base 10 such that the flexible curvature may be flexibly displaced to slidably receive business deposit book 5 opened to a desired position with pages 7 folded over spine 9 so as to retain business deposit book 5 in said desired position. The flexible curvature is arched and adapted to accommodate the shape and configuration of pages 7 folded over spine 9. Curvature 8 formed by pages 7 folded over spine 9 may be received in the arch shape of the flexible curvature. The flexible curvature may be configured to accommodate the shape and configuration of curvature 8 so as to retain pages 7 in the folded over position when business deposit book 5 is opened to the desired position. Curvature 8 slidably received in the arch of the flexible curvature effectively counters the natural tendency of folded over pages 7 from folding back over spine 9 to close business deposit book 5 by maintaining folded over pages 7 within the arch of the flexible curvature. Business deposit book 5 may be slidably removed from arm device 1 when desired.

In an embodiment of the invention, base 10 may further comprise at least one stabilizing means configured frictionally engage a surface receiving device 1 may rest on when in use such that receiving device 1 may remain generally stationary on the surface while in use. Stabilizing means include any non-skid or non-slip material such as but not limited to rubber and adhesives. Stabilizing means may be mounted with base 10 on a second side 14 opposing first side 12. Preferably, stabilizing means are rubber feet 18 mounted on second side 14 such that when receiving device 1 rests on a surface, rubber feet 18 frictionally engages the surface so as to maintain base 10 in a stationary position. Rubber feet 18 also elevate base 10 from the surface.

The foregoing description is made for purpose of illustration only and is not intended to limit the scope of the invention. From the foregoing, it should be clear that the present invention may be embodied in other forms other than those disclosed above without departing from the spirit or essential characteristics of the invention. The above described embodiments are therefore to be considered in all respects illustrative and not restrictive.

I claim:

1. A receiving device for a book, said device comprising:
(a) a base; and
(b) an arm pivotally coupled with said base by way of at least one pivot means such that said arm may pivot between a first open position and a second closed position relative to said base
wherein said arm may be maintained in said first open position or said second closed position unless adjusted otherwise.

2. The receiving device of claim 1 wherein said book may be received on said base in a desired open position when said arm is in said first open position and said book may be retained in said desired open position when said arm is displaced from said first open position to said second closed position such that said arm engages said book

3. The receiving device of claim 2 wherein said arm is arched and adapted to accommodate said book when said book is folded over its binding when said book is in said desired open position.

4. A receiving device for a book, said device comprising:
(a) a base; and
(b) a flexible curvature at an end of said base
wherein said flexible curvature may be flexibly displaced to slidably receive said book in a desired open position so as to retain said book in said desired open position.

5. A method of retaining a book in a desired open position in the receiving device of claim 1, the method comprising the steps of:
(a) opening said book in said desired position such that pages said book 5 may be folded over a spine of said book, thereby forming a curvature on a first side of said book 5 while pages on a second side of said book 5 remain in a relatively flat plane;
(b) displacing said arm of said receiving device in said first open position;
(c) placing said book in said desired position on said base of said receiving device; and
(d) displacing said arm of said receiving device from said first open position to said second position such that said curvature formed by pages of said book folded over said spine may be received in said arm.
